(19) United States
(12) Patent Application Publication
(10) Pub. No.: US 2026/0339315 A1
(43) Pub. Date: Oct. 29, 2026

(54) SWARM LEVEL ANALYTICS

(71) Applicant: Rockwell Automation Technologies, Inc., Mayfield Heights, OH (US)

(72) Inventor: Michael A. Spaner, Deep River, CT (US)

(21) Appl. No.: 19/191,922

(22) Filed: Apr. 28, 2025

(51) Int. Cl. G05B 23/02

(52) U.S. Cl. CPC G05B 23/0275; G05B 23/0216; G05B 23/0248

(57) ABSTRACT

An industrial automation system includes industrial automation devices and a control system, such that the control system includes processing circuitry and a memory configured to store instructions that, when executed by the processing circuitry, cause the processing circuitry to receive a first dataset of a first industrial automation device, receive a second dataset of a second industrial automation device, and receive fault data corresponding to faults that occurred on the first industrial automation device. Additionally, the instructions cause the processing circuitry to identify a correlation between the datasets and the fault data, determine a weight for the first dataset, the second dataset, or both, identify a root cause for the faults based on the correlation, identify one or more datasets and a subset of the one or more industrial automation devices related to the root cause, and adjust a data acquisition parameter for a sensor configured to acquire the datasets.

### BACKGROUND

This disclosure generally relates to systems and methods for determining a root cause for a fault within an industrial automation system. More particularly, embodiments of the present disclosure are directed towards collecting operations data of multiple industrial automation devices and identifying inputs of the multiple industrial automation devices that may have contributed to the fault.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Industrial automation systems may include automation control and monitoring systems. The automation control and monitoring systems may monitor statuses and/or receive sensor data from a wide range of devices as they operate. At times, the devices within the industrial automation system may experience a fault, operate less efficiently, stop operating, or change its operation. When this occurs, as a portion of a troubleshooting process, the control and monitoring system may attempt to diagnose and determine a root cause of the fault experienced by the industrial automation device. However, as complexity (e.g., number of automation devices and/or amounts of sensor data) of an industrial automation system increases, a corresponding complexity of monitoring and/or diagnostics may also increase. As such, it may be beneficial to improve methods for analyzing and determining root causes of faults within an industrial automation system.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, an industrial automation system includes one or more industrial automation devices and one or more control systems, such that the one or more control systems include processing circuitry and a memory configured to store instructions that, when executed by the processing circuitry, cause the processing circuitry to receive a first input variable dataset associated with a first set of operations of a first industrial automation device over a period of time, receive a second input variable dataset associated with a second set of operations of a second industrial automation device over the period of time, and receive fault data corresponding to one or more faults that occurred on the first industrial automation device. Additionally, the instructions cause the processing circuitry to identify at least one correlation, at least one causal relationship, or both, between the first input variable dataset, the second input variable dataset, the fault data, or any combination thereof, determine at least one weight for the first input variable dataset, the second input variable dataset, or both based on the at least one correlation, the at least one causal relationship, or both, identify a root cause for the one or more faults based on the at least one correlation, the at least one causal relationship, the at least one weight, or any combination thereof, identify one or more datasets and a subset of the one or more industrial automation devices related to the root cause, and adjust at least one data acquisition parameter for at least one sensor configured to acquire the one or more datasets.

In another embodiment, a method includes receiving, via processing circuitry, a first input variable dataset associated with a first set of operations of a first industrial automation device over a period of time, receiving, via the processing circuitry, a second input variable dataset associated with a second set of operations of a second industrial automation device over the period of time, and receiving, via the processing circuitry, fault data corresponding to one or more faults that occurred on the first industrial automation device. The method further includes identifying, via the processing circuitry, at least one correlation, at least one causal relationship, or both, between the first input variable dataset, the second input variable dataset, the fault data, or any combination thereof, determining, via the processing circuitry, at least one weight for the first input variable dataset, the second input variable dataset, or both based on the at least one correlation, the at least one causal relationship, or both, identifying, via the processing circuitry, a root cause for the one or more faults based on the at least one correlation, the at least one causal relationship, the at least one weight, or any combination thereof, identifying, via the processing circuitry, one or more datasets and a subset of the one or more industrial automation devices related to the root cause, and adjusting, via the processing circuitry, at least one data acquisition parameter for at least one sensor configured to acquire the one or more datasets.

In yet another embodiment, a non-transitory computer-readable medium including computer-executable instructions that, when executed by at least one processor, cause the at least one processor to perform operations including receiving a first input variable dataset associated with a first set of operations of a first industrial automation device over a period of time, receiving a second input variable dataset associated with a second set of operations of a second industrial automation device over the period of time, and receiving fault data corresponding to one or more faults that occurred on the first industrial automation device. Additionally, the operations include identifying at least one correlation, at least one causal relationship, or both, between the first input variable dataset, the second input variable dataset, the fault data, or any combination thereof, determining at least one weight for the first input variable dataset, the second input variable dataset, or both based on the at least one correlation, the at least one causal relationship, or both, identifying a root cause for the one or more faults based on the at least one correlation, the at least one causal relationship, the at least one weight, or any combination thereof, identifying one or more datasets and a subset of the one or more industrial automation devices related to the root cause, and adjusting at least one data acquisition parameter for at least one sensor configured to acquire the one or more datasets.

### BRIEF DESCRIPTION OF THE DRA WINGS

These and other features, aspects, and advantages of the present disclosure may become better understood when the following detailed description is read with reference to the accompanying drawings in which like characters represent like parts throughout the drawings, wherein:

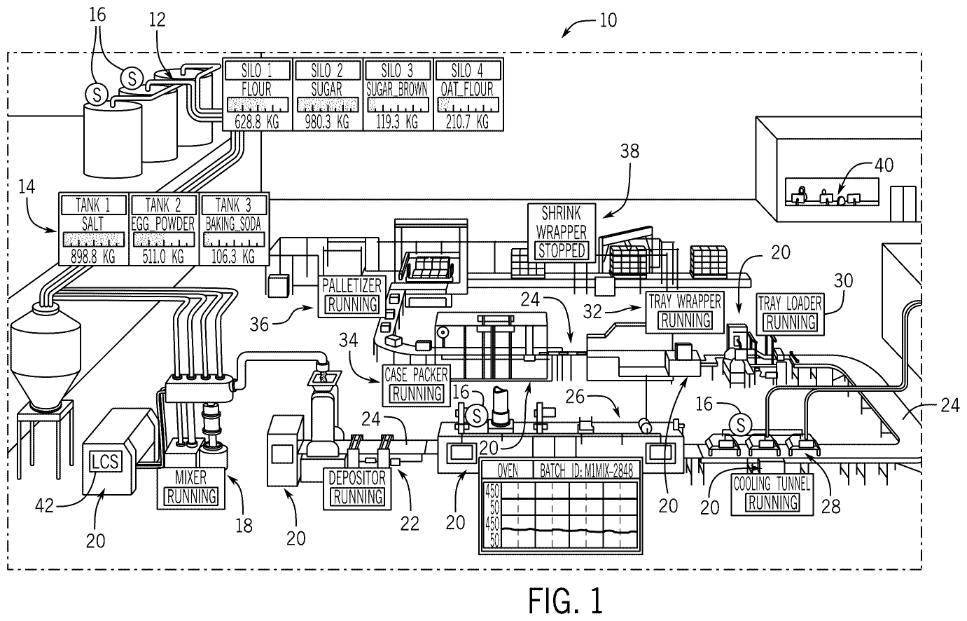

FIG. 1 illustrates an example industrial automation system employed by a food manufacturer, in accordance with an embodiment;

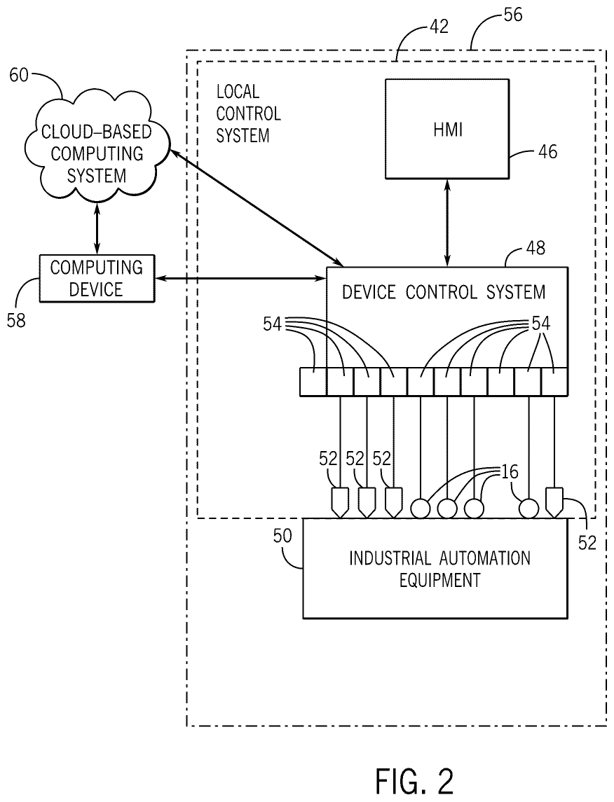

FIG. 2 illustrates a diagrammatical representation of an exemplary local control system that may be employed in any suitable industrial automation system, in accordance with an embodiment;

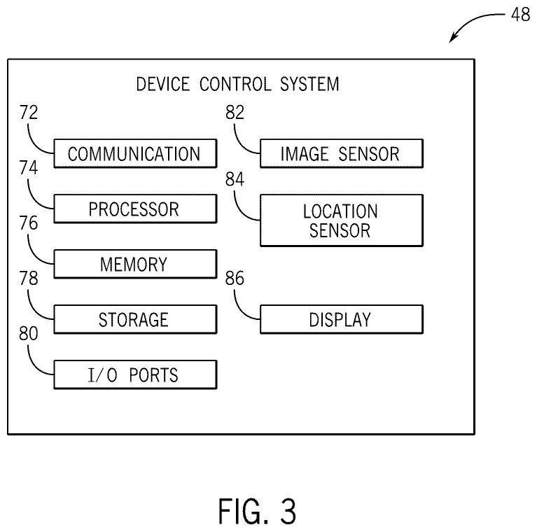

FIG. 3 illustrates example components that may be part of an edge device of the local control system data, in accordance with an embodiment;

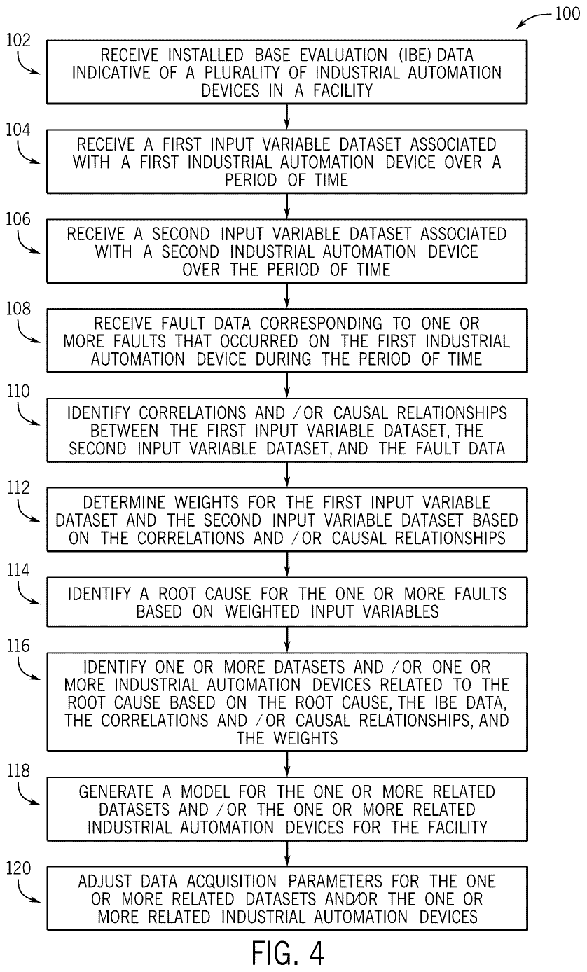

FIG. 4 illustrates a flow chart of a method for generating a model for root cause analysis, in accordance with an embodiment; and

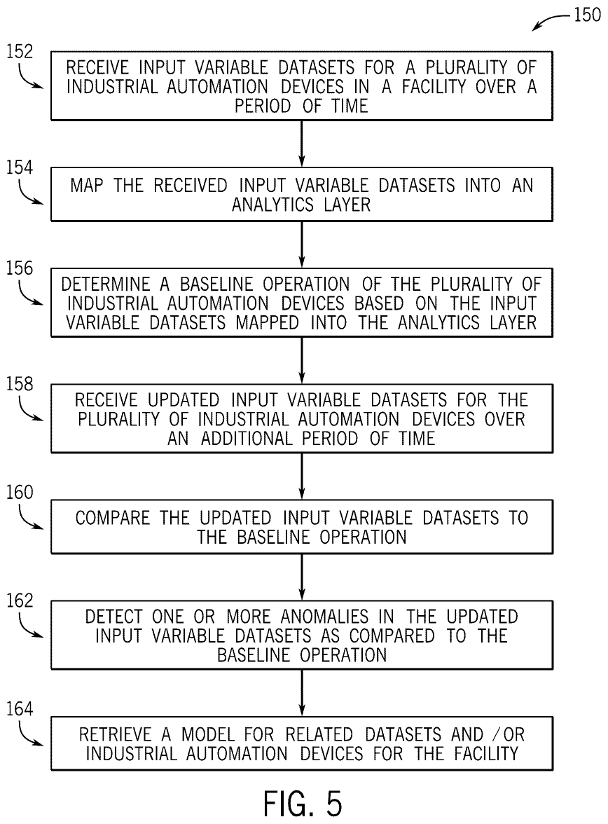

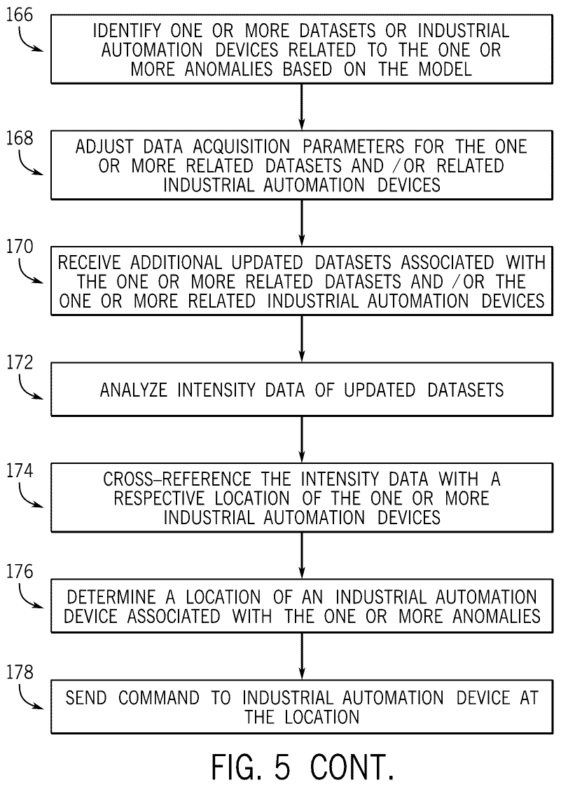

FIG. 5 illustrates a flow chart of a method for determining a location of an industrial automation device associated with one or more anomalies detected in one or more related datasets, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Present embodiments are directed towards a system and method for identifying potential root causes for a fault in an industrial automation system device. That is, as industrial automation devices within an industrial automation system operate, the devices may periodically operate less efficiently, stop operating, or change their operations at some instances. When the device experiences a fault or experiences a condition that otherwise forces the device to stop, an analysis of various datasets in a time period leading up to the instance of the fault or after the occurrence of the fault may provide useful information to help determine potential causes of the fault. In certain embodiments, analyzing datasets from additional devices that are operating in physical proximity or logical proximity (in the case of networked devices) to the device experiencing the fault may provide insight into determining potential causes of the fault. The datasets from the additional devices may include several distinct inputs or variables that may be related to or affect a single output variable, such as the occurrence of a fault, an anomaly, or the like. Although each of these inputs may affect the output variable, one or more of the inputs may prove to be more closely linked with the output variable as compared to others.

With this in mind, in some embodiments, monitoring datasets from the additional devices during operation may assist in identifying the root cause of a fault of a device. By way of operations, a data collection system may collect and store the monitored datasets that may include the input variables from all devices within the industrial automation system. However, since computing and operational limitations may prevent the data collection system from storing the datasets that include all of the input variables at a particular frequency or rate (e.g., above some threshold frequency), the data collection system may prioritize the storage of particular input variables over others based on a respective weight associated with the respective input variable. To this end, the data collection system may prioritize the storage of particular input variables over others based on a respective weight associated with the respective input variable. As such, the data collection system may monitor a first input variable at a first frequency, while monitoring a second input variable at a lower frequency based on their respective weights with respect to a particular output variable.

In certain embodiments, the data collection system may aggregate together the monitored datasets and prioritize input variables from the various industrial automation devices into an analytics layer of data. Additionally, the data collection system may include data analysis containers operating on an edge device (e.g., gateway, router) of the industrial automation system that may retrieve and analyze portions of the aggregated data layer to determine a cause of the fault. By retrieving and analyzing datasets from devices that may be within a proximity threshold of the device experiencing the fault (i.e., swarm analytics), the present embodiments may identify the root cause and determine operational adjustments for the respective device more efficiently by processing or evaluating a subset of data related to the fault on devices within the proximity threshold, as opposed to evaluating a larger dataset that may include irrelevant or less impactful data.

In other embodiments, the data analysis containers may determine a location within the industrial automation system of an event (e.g., collision, power disruption, fire, leak, etc.) that may have created conditions that caused the device to experience a fault. By analyzing an intensity of anomalies in the dataset input variables from a determined baseline and cross-referencing these anomaly intensities with pre-determined locations of the devices within the industrial automation system, the containers may determine the location of the event. Additionally, the containers may provide an additional analytics layer that determines causal relationships between input variables and additional elements. For example, by utilizing swarm analytics, the containers may analyze the input variables as part of the datasets and determine additional variables that influence the inputs (e.g., environmental conditions, power profiles, vibrations, motion profiles, etc.).

Additionally, in certain embodiments, the data collection system may employ artificial intelligence algorithms to dynamically adjust the datasets being monitored, the frequencies in which each dataset may be monitored, the baseline for respective variable inputs, and the like based on expected faults, changes in weights, and the like. For example, the data collection system may receive a notification or update from other systems that may indicate a change in weight for a particular input variable, a change in priority of output variables (e.g., types of faults) that may be expected for a particular device, or the like. The notification may be generated based on an AI analysis of a collection of datasets from various devices across a region or area over some period of time. Based on the notification, the data collection system may adjust the monitoring operations of the respective datasets to capture the datasets that may be more relevant to the operation of the respective device in view of the AI findings. In other embodiments, the data collection system may utilize the AI algorithms to build the system notifications model automatically. In this way, the data collection system may continuously evaluate and dynamically monitor data that may likely be more related to the fault and/or anomaly to provide insight into the root cause of the fault and/or anomaly.

By way of introduction, FIG. 1 illustrates an example industrial automation system 10 employed by a food manufacturer. It should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto a conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to a case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may be used to provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In certain embodiments, the supervisory control system 40 may receive data relating to one or more inputs received by a respective device during operation, and in other embodiments, may receive data relating to one or more outputs of the respective device during operation. Additionally or alternatively, the supervisory control system 40 may receive data relating to one or more additional inputs received by additional devices in a proximate location of the respective device. In some embodiments, each industrial automation device 20 or a group of industrial automation devices 20 may be controlled using a local control system 42. That is, the local control system 42 may receive data relating to one or more inputs received by a respective device during operation, and in other embodiments, may receive data relating to one or more outputs of the respective device during operation. In any case, the data may include datasets that correspond to the operation of the respective industrial automation device 20, other industrial automation devices 20, user inputs, other suitable inputs to control the operations of the respective industrial automation device(s) 20, and outputs of the respective industrial automation device 20 during operation.

The one or more industrial automation devices 20 may be organized and/or grouped together within the industrial automation system 10 as a portion of an installed base evaluation (IBE) of the facility. For example, in order to contextualize data from the one or more datasets associated with the facility, the IBE may provide a layout of the industrial automation system 10 that indicates a physical location of the machines and associated industrial automation devices 20 that work to control the various operations of the machines within the industrial automation system 10. That is, the IBE may provide information relating to how the operations of a particular industrial automation device 20 may be affected by the operations of other industrial automation devices 20 operating proximate to the particular industrial automation device 20. In some embodiments, the IBE may include information (e.g., bills of materials, spare parts lists, etc.) relating to the industrial automation devices 20 operating in the facility.

In some cases, an industrial automation device 20 may periodically experience a fault (e.g., operate less efficiently, stop operating, or change its operation at some instances). When the industrial automation device 20 experiences the fault or experiences a condition that otherwise may force the industrial automation device 20 to stop, the supervisory control system 40 and/or the local control system 42 may analyze the datasets regarding the operation of the other industrial automation devices 20 located within a proximity to the industrial automation device 20 experiencing the fault. That is, the supervisory control system 40 and/or the local control system 42 may analyze datasets that generally correspond to inputs that control the operations of the respective industrial automation device 20 in addition to the inputs that control the operations of the other industrial automation devices 20 near the respective industrial automation device 20 during a time period leading up to the instance of the fault, datasets that include measurements of variables detected from sensors 16, datasets interpolated by other computing devices, and the like. By performing this analysis, the supervisory control system 40 and/or the local control system 42 may determine potential causes of the fault based on changes within the datasets during a time period prior to the detected fault. In certain embodiments, the supervisory control system 40 and/or the local control system 42 may determine that one or more of the parameters of the datasets may be more closely linked or correlated with an output variable than one or more of the remaining inputs. As discussed in further detail below, the supervisory control system 40 and/or the local control system 42 may, as a result of the aforementioned analysis, provide weights to the one or more inputs to the respective industrial automation device 20.

To illustrate certain embodiments in which the local control system 42 may be communicatively coupled to other devices, FIG. 2 illustrates a diagrammatical representation of an embodiment of the local control system 42 that may be employed in any suitable industrial automation system 10, in accordance with embodiments presented herein. In FIG. 2, the local control system 42 is illustrated as including a human machine interface (HMI) 46 and a device control system 48 or automation controller adapted to interface with devices that may monitor and control various types of industrial automation equipment 50. By way of example, the industrial automation equipment 50 may include the mixer 18, the depositor 22, the conveyor 24, the oven 26, and the other pieces of machinery described in FIG. 1.

It should be noted that the HMI 46 and the control/monitoring device 54, in accordance with embodiments of the present techniques, may be facilitated by the use of certain network strategies. Indeed, an industry standard network may be employed, such as DeviceNet, to enable data transfer. Such networks permit the exchange of data in accordance with a predefined protocol and may provide power for operation of networked elements.

As discussed above, the industrial automation equipment 50 may take many forms and include devices for accomplishing many different and varied purposes. For example, the industrial automation equipment 50 may include machinery used to perform various operations in a compressor station, an oil refinery, a batch operation for making food items, a mechanized assembly line, and so forth. Accordingly, the industrial automation equipment 50 may include a variety of operational components, such as electric motors, valves, actuators, temperature elements, pressure sensors, or a myriad of machinery or devices used for manufacturing, processing, material handling, and other applications.

Additionally, the industrial automation equipment 50 may include various types of equipment that may be used to perform the various operations that may be part of an industrial application. For instance, the industrial automation equipment 50 may include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation equipment 50 may be made up of certain automation devices 20, which may include controllers, input/output (I/O) modules, motor control centers, motors, human machine interfaces (HMIs), operator interfaces, contactors, starters, sensors 16, actuators, drives, relays, protection devices, switchgear, compressors, firewall, network switches (e.g., Ethernet switches, modular-managed, fixed-managed, service-router, industrial, unmanaged, etc.) and the like.

In certain embodiments, one or more properties of the industrial automation equipment 50 may be monitored and controlled by certain equipment for regulating control variables used to operate the industrial automation equipment 50. For example, the sensors 16 may monitor various properties of the industrial automation equipment 50 and actuators 52 may adjust operations of the industrial automation equipment 50, respectively. In some cases, the adjusted operations may be put into place in response to the industrial automation equipment experiencing a fault or otherwise stopping operations. In some embodiments, the device control system 48 may output a command to adjust one or more operations of the industrial automation equipment 50 or the industrial automation device 20 in response to results from a root cause analysis that was conducted after detecting the fault.

In some cases, the industrial automation equipment 50 may be associated with devices used by other equipment. For instance, scanners, gauges, valves, flow meters, and the like may be disposed on industrial automation equipment 50. Here, the industrial automation equipment 50 may receive data from the associated devices and use the data to perform their respective operations more efficiently. For example, a controller (e.g., device control system 48) of a motor drive may receive data regarding the temperature of a connected motor and may adjust operations of the motor drive based on the data. To further build off the example above, if the temperature of the connected motor rises above a threshold temperature (e.g., 250° F., 300° F., 400° F., 500° F., etc.), the device control system 48 may output a command to reduce the rotational speed of the motor, reduce a rotational torque output of the motor, or otherwise stop the motor. In other embodiments, the device control system 48 may receive and store a dataset corresponding to the temperature of the connected motor that may be retrieved for a subsequent root cause analysis.

In certain embodiments, the industrial automation equipment 50 may include a communication component that enables the industrial automation equipment 50 to communicate data between each other and other devices. The communication component may include a network interface that may enable the industrial automation equipment 50 to communicate via various protocols such as Ethernet/IP®, ControlNet®, DeviceNet®, or any other industrial communication network protocol. Alternatively, the communication component may enable the industrial automation equipment 50 to communicate via various wired or wireless communication protocols, such as Wi-Fi, mobile telecommunications technology (e.g., 2G, 3G, 4G, 5G, LTE), Bluetooth®, near-field communications technology, and the like.

The sensors 16 may be any number of devices adapted to provide information regarding process conditions. The actuators 52 may include any number of devices adapted to perform a mechanical action in response to a signal from a controller (e.g., the device control system 48). The sensors 16 and actuators 52 may be utilized to operate the industrial automation equipment 50. Indeed, they may be utilized within process loops that are monitored and controlled by the device control system 48 and/or the HMI 46. Such a process loop may be activated based on process inputs (e.g., input from a sensor 16) or direct operator input received through the HMI 46. As illustrated, the sensors 16 and actuators 52 are in communication with the device control system 48. Further, the sensors 16 and actuators 52 may be assigned a particular address in the device control system 48 and receive power from the device control system 48 or attached modules.

Input/output (I/O) modules 54 may be added or removed from the local control system 42 via expansion slots, bays or other suitable mechanisms. In certain embodiments, the I/O modules 54 may be included to add functionality to the device control system 48, or to accommodate additional process features. For instance, the I/O modules 54 may communicate with new sensors 16 or actuators 52 added to monitor and control the industrial automation equipment 50. It should be noted that the I/O modules 54 may communicate directly to sensors 16 or actuators 52 through hardwired connections or may communicate through wired or wireless sensor networks, such as Hart or IOLink.

Generally, the I/O modules 54 serve as an electrical interface to the device control system 48 and may be located proximate or remote from the device control system 48, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

In the illustrated embodiment, several of the I/O modules 54 may transfer input and output signals between the device control system 48 and the industrial automation equipment 50. As illustrated, the sensors 16 and actuators 52 may communicate with the device control system 48 via one or more of the I/O modules 54 coupled to the device control system 48. Additionally or alternatively, the device control system 48 may convert the input and output signals into a machine-readable dataset that may be stored and retrieved at a later time. For example, an input signal output from an I/O module 54 to an actuator 52 configured to cause a motor coupled to the industrial automation equipment 50 to rotate may be received by the device control system 48 and converted into a dataset, and the dataset may be saved in a memory of the device control system 48. As discussed in further detail below, the device control system 48 may retrieve this saved machine-readable dataset for analysis at a later time.

In certain embodiments, the local control system 42 (e.g., the HMI 46, the device control system 48, the sensors 16, the actuators 52, the I/O modules 54) and the industrial automation equipment 50 may make up an industrial automation application 56. The industrial automation application 56 may involve any type of industrial process or system used to manufacture, produce, process, or package various types of items. For example, the industrial automation application 56 may include industries such as material handling, packaging industries, manufacturing, processing, batch processing, the example industrial automation system 10 of FIG. 1, and the like.

In certain embodiments, the device control system 48 may be communicatively coupled to an edge computing device 58 and a cloud-based computing system 60. In this network, input and output signals generated from the device control system 48 may be communicated between the edge computing device 58 and the cloud-based computing system 60. Although the device control system 48 may be capable of communicating with the edge computing device 58 and the cloud-based computing system 60, as mentioned above, in certain embodiments, the device control system 48 (e.g., local control system 42) may perform certain operations and analysis without sending data to the edge computing device 58 or the cloud-based computing system 60.

In some embodiments, the edge computing device 58 may include data analysis containers that operate on the edge computing device 58. For example, the data analysis containers may receive input and output signals that may include one or more datasets corresponding to one or more input variables and an output variable for one or more industrial automation devices 20. In this way, the edge computing device 58 may, based on the received input and output signals, initiate a root cause analysis of a fault experienced during an operation of the industrial automation device 20. In certain embodiments, the edge computing device 58 may identify the root cause and determine operational adjustments for the respective industrial automation device 20 and/or other industrial automation devices 20 located proximate to the respective industrial automation device more efficiently by processing or evaluating a subset of the received datasets, as opposed to a larger dataset that may include irrelevant or less impactful data.

In any case, FIG. 3 illustrates example components that may be part of the device control system 48, in accordance with embodiments presented herein. For example, the device control system 48 may include a communication component 72, a processor 74, a memory 76, a storage 78, input/output (I/O) ports 80, an image sensor 82 (e.g., a camera), a location sensor 84, a display 86, additional sensors (e.g., vibration sensors, temperature sensors), and the like. The communication component 72 may be a wireless or wired communication component that may facilitate communication between the industrial automation equipment 50, the cloud-based computing system 60, and other communication capable devices.

The processor 74 may be any type of computer processor or microprocessor capable of executing computer-executable code. The processor 74 may also include multiple processors that may perform the operations described below. The memory 76 and the storage 78 may be any suitable articles of manufacture that can serve as media to store processor-executable code, data, or the like. These articles of manufacture may represent computer-readable media (e.g., any suitable form of memory or storage) that may store the processor-executable code used by the processor 74 to perform the presently disclosed techniques. Generally, the processor 74 may execute software applications that include programs that enable a user to track and/or monitor operations of the industrial automation equipment 50 via a local or remote communication link. That is, the software applications may communicate with the device control system 48 and gather information associated with the industrial automation equipment 50 as determined by the device control system 48, via the sensors 16 disposed on the industrial automation equipment 50 and the like.

The memory 76 and the storage 78 may also be used to store the data, analysis of the data, the software applications, and the like. For example, the memory 76 and the storage 78 may store datasets relating to the operation of a respective industrial automation device 20. That is, the datasets may include input variables and/or output variables that correspond to the operation of the respective industrial automation device 20. In some embodiments, the storage 78 may store the datasets on a fixed buffer or otherwise suitable storage component. In other embodiments, the storage 78 may store the datasets in a circular buffer (e.g., first dataset in-first dataset out) to capture relevant datasets over a previous period of time. In some embodiments, the circular buffer may store a dataset over 10 seconds, 60 seconds, 2 minutes, 5 minutes, 15 minutes, 3 hours, 2 days, or any otherwise appropriate duration. For example, if a determination is made that a first input variable is closely related to an industrial automation device experiencing a fault, then the device control system 48 may store the first input variable in a circular buffer with an increased frequency to ensure that a sufficient amount of data related to the first input variable may be available for analysis. Additionally or alternatively, if the device control system 48 determines that the first input variable is less correlated to the presence of a fault, the device control system 48 may store the datasets related to the first input variable with a lower frequency than previously used to preserve more of the circular buffer to store data related to other input variables that may be more relevant to other faults.

In addition to a specified duration that the memory 76 and storage 78 may store the multiple datasets, the device control system 48 may output a control signal to store a particular input variable dataset at an increased frequency (e.g., above a threshold frequency). For example, to follow up on the example from above, if the first input variable is determined to be closely linked to an industrial automation device 20 experiencing a fault, the first input signal corresponding to the first input variable may be recorded at a high frequency (e.g., one reading every second, 5 readings per second, 30 readings per second, etc.) as compared to other input variables. Relatedly, if a determination is made by the device control system 48 that a particular input variable, different from the first input variable, is not closely linked to the industrial automation device 20 experiencing a fault, then the device control system 48 may store an input signal corresponding to the particular input variable at a lower frequency, below a certain frequency threshold (e.g., one reading per minute, one reading every five minutes, a reading once an hour, etc.). To achieve this, the device control system 48 may assign a first weight to a first input variable and a second weight to a second input variable, such that the first weight is higher than the second weight. In some embodiments, the higher weight associated with the first input variable may indicate to the local control system 42 that the first input variable may be stored at a rate exceeding the frequency threshold, while the second input variable may be stored at a rate below the frequency threshold. In this way, the device control system 48 may prioritize the storage of particular input variables over others based on a respective weight associated with the respective input variable.

The memory 76 and the storage 78 may represent non-transitory computer-readable media (e.g., any suitable form of memory or storage) that may store the processor-executable code used by the processor 74 to perform various techniques described herein. It should be noted that non-transitory merely indicates that the media is tangible and not a signal.

In one embodiment, the memory 76 and/or storage 78 may include a software application that may be executed by the processor 74 and may be used to monitor, control, access, or view one of the industrial automation equipment 50. As such, the edge computing device 58 may communicatively couple to industrial automation equipment 50 or to a respective computing device of the industrial automation equipment 50 via a direct connection between the devices or via the cloud-based computing system 60. The software application may perform various functionalities, such as track statistics of the industrial automation equipment 50, store reasons for placing the industrial automation equipment 50 offline, determine reasons for placing the industrial automation equipment 50 offline, secure industrial automation equipment 50 that is offline, deny access to place an offline industrial automation equipment 50 back online until certain conditions are met, and so forth.

The I/O ports 80 may be interfaces that may couple to other peripheral components such as input devices (e.g., keyboard, mouse), sensors, input/output (I/O) modules 54, and the like. I/O modules 54 may enable the edge computing device 58 or other device control systems 48 to communicate with the industrial automation equipment 50 or other devices in the industrial automation system via the I/O modules 54.

The image sensor 82 may include any image acquisition circuitry such as a digital camera capable of acquiring digital images, digital videos, or the like. The location sensor 84 may include circuitry designed to determine a physical location of the device control system 48. In one embodiment, the location sensor 84 may include a global positioning system (GPS) sensor that acquires GPS coordinates for the device control system 48.

The display 86 may depict visualizations associated with software or executable code being processed by the processor 74. In one embodiment, the display 86 may be a touch display capable of receiving inputs (e.g., parameter data for operating the industrial automation equipment 50) from a user of the device control system 48. As such, the display 86 may serve as a user interface to communicate with the industrial automation equipment 50. The display 86 may be used to display a graphical user interface (GUI) for operating the industrial automation equipment 50, for tracking the maintenance of the industrial automation equipment 50, and the like. The display 86 may be any suitable type of display, such as a liquid crystal display (LCD), plasma display, or an organic light emitting diode (OLED) display, for example. Additionally, in one embodiment, the display 86 may be provided in conjunction with a touch-sensitive mechanism (e.g., a touch screen) that may function as part of a control interface for the industrial automation equipment 50 or for a number of pieces of industrial automation equipment in the industrial automation application 56, to control the general operations of the industrial automation application 56. In some embodiments, the operator interface may be characterized as the HMI 46, a human-interface machine, or the like.

In a non-limiting embodiment, the display 86 may depict a visualization of a notification indicative of a fault experienced by an industrial automation device 20 or by the industrial automation equipment 50. The notification may indicate a component of the device or equipment that experienced the fault, a time of the fault, or otherwise useful information that may be utilized to resolve the fault. Additionally or alternatively, the device control system 48, upon receiving the notification, may retrieve one or more of the datasets stored in the circular buffer and perform a root cause analysis on the respective datasets to identify the root cause of the fault. In this way, based on the weights assigned to the respective input variables, the root cause analysis may be completed in an efficient manner, as the device control system 48 may not review or analyze datasets deemed irrelevant to an output (e.g., the fault) of the industrial automation device 20 or the industrial automation equipment 50.

Although the components described above have been discussed with regard to the device control system 48, it should be noted that similar components may make up other computing devices described herein. Further, it should be noted that the listed components are provided as example components and the embodiments described herein are not to be limited to the components described with reference to FIG. 3.

Referring back to FIG. 2, in operation, the industrial automation application 56 may receive one or more inputs used to produce one or more outputs. For example, the inputs may include feedstock, electrical energy, fuel, parts, assemblies, sub-assemblies, operational parameters (e.g., sensor measurements), or any combination thereof. Additionally, the outputs may include finished products, semi-finished products, assemblies, manufacturing products, by products, or any combination thereof.

To produce the one or more outputs, the device control system 48 may control operation of the industrial automation application 56. In some embodiments, the device control system 48 may control operation by outputting control signals to instruct industrial automation equipment 50 to perform a control action by implementing manipulated variable set points. For example, the device control system 48 may instruct a motor (e.g., an automation device 20) to implement a control action by actuating at a particular speed (e.g., a manipulated variable set point).

In some embodiments, the device control system 48 may determine the manipulated variable set points based at least in part on process data. As described above, the process data may be indicative of an operation of the particular industrial automation device 20, other industrial automation devices 20 located proximate to the particular industrial automation device, the industrial automation equipment 50, the industrial automation application 56, and the like. As such, the process data may include operational parameters of the industrial automation device 20 and/or operational parameters of the industrial automation application 56. For example, the operational parameters may include any suitable type, such as temperature, flow rate, electrical power, and the like.

Thus, the device control system 48 may receive process data from one or more of the industrial automation devices 20, the sensors 16, or the like. In some embodiments, a sensor 16 may determine an operational parameter and communicate a measurement signal indicating the operational parameter to the device control system 48. For example, a temperature sensor may measure the temperature of a motor (e.g., an automation device 20) and transmit a measurement signal indicating the measured temperature to the device control system 48. The device control system 48 may then analyze the process data to monitor performance of the industrial automation application 56 (e.g., determine an expected operational state) and/or perform diagnostics on the industrial automation application 56.

To facilitate controlling operation and/or performing other functions, the device control system 48 may include one or more controllers, such as one or more model predictive control (MPC) controllers, one or more proportional-integral-derivative (PID) controllers, one or more neural network controllers, one or more fuzzy logic controllers, or any combination thereof.

In some embodiments, the supervisory control system 40 may provide centralized control over operation of the industrial automation application 56. For example, the supervisory control system 40 may enable centralized communication with a user (e.g., operator). To facilitate, the supervisory control system 40 may include the display 86 to facilitate providing information to the user. For example, the display 86 may display visual representations of information, such as process data, selected features, expected operational parameters, and/or relationships there between. Additionally, the supervisory control system 40 may include similar components as the device control system 48 described above in FIG. 3.

On the other hand, the device control system 48 may provide localized control over a portion of the industrial automation application 56 via the local control system 42. For example, in the depicted embodiment of FIG. 1, the local control system 42 that may be part of the mixer 18 may provide control over operation of a first automation device 20 that controls the mixer 18, and a second local control system 42 may provide control over operation of a second automation device 20 that controls the operation of the depositor 22.

In some embodiments, the local control system 42 may control operation of a portion of the industrial automation application 56 based at least in part on the control strategy determined by the supervisory control system 40. Additionally, the supervisory control system 40 may determine the control strategy based at least in part on process data determined by the local control system 42. Thus, to implement the control strategy, the supervisory control system 40 and the local control systems 42 may be communicatively coupled via a network, which may be any suitable type, such as an Ethernet/IP network, a ControlNet network, a DeviceNet network, a Data Highway Plus network, a Remote I/O network, a Foundation Fieldbus network, a Serial, DH-485 network, a SynchLink network, or any combination thereof.

Some analysis processes (e.g., identifying a root cause for a fault, determining an input variable more closely linked to the fault, etc.) described above may be performed by machine learning circuitry and/or algorithms using the one or more input variable datasets and the output of the industrial automation device 20. The machine learning circuitry (e.g., circuitry used to implement machine learning algorithms or logic) may access the one or more input variable datasets and the output of a particular industrial automation device 20 and/or other industrial automation devices 20 located proximate to the particular industrial automation device 20 to identify patterns, correlations, causal relationships or trends associated with the data. As a result, new data patterns not previously attainable without machine learning based on the one or more input variable datasets may emerge. As used herein, machine learning may refer to algorithms and statistical models that computer systems use to perform a specific task with or without using explicit instructions. For example, a machine learning process may generate a mathematical model based on a sample of the clean data, known as “training data,” in order to make predictions or decisions without being explicitly programmed to perform the task.

Depending on the inferences to be made, the machine learning circuitry may implement different forms of machine learning. In some embodiments, supervised machine learning may be implemented. In supervised machine learning, the mathematical model of a set of transaction data contains both the inputs and the desired outputs. The set of transaction data is referred to as “training data” and is essentially a set of training examples. Each training example has one or more inputs and the desired output, also known as a supervisory signal. In a mathematical model, each training example is represented by an array or vector, sometimes called a feature vector, and the training data is represented by a matrix. Through iterative optimization of an objective function, supervised learning algorithms learn a function that can be used to predict the output associated with new inputs. An optimal function will allow the algorithm to correctly determine the output for inputs that were not a part of the training data. An algorithm that improves the accuracy of its outputs or predictions over time is said to have learned to perform that task.

Supervised learning algorithms may include classification and regression. Classification algorithms are used when the outputs are restricted to a limited set of values, and regression algorithms are used when the outputs may have any numerical value within a range. Similarity learning is an area of supervised machine learning closely related to regression and classification, but the goal is to learn from examples using a similarity function that measures how similar or related two occurrences (e.g. a drive motor beginning to increase a rotational speed increase and a fault for the particular industrial automation device 20) are.

Additionally and/or alternatively, in some situations, it may be beneficial for the machine-learning circuitry to utilize unsupervised learning (e.g., when particular output types are not known). Unsupervised learning algorithms take a set of transaction data that contains only inputs, and find structure in the data, like grouping or clustering of transaction data. The algorithms, therefore, learn from test data that has not been labeled, classified or categorized. Instead of responding to feedback, unsupervised learning algorithms identify commonalities in the one or more input variable datasets and react based on the presence or absence of such commonalities in each new piece of output variable data.

Cluster analysis is the assignment of a set of observations (e.g., operational characteristics of the industrial automation equipment 50) into subsets (called clusters) so that observations within the same cluster are similar according to one or more predesignated criteria, while observations drawn from different clusters are dissimilar. Different clustering techniques make different assumptions on the structure of the datasets of the input variables, often defined by some similarity metric and evaluated, for example, by internal compactness, the similarity between clusters, and separation, the difference between clusters. Predictions or correlations may be derived by the machine learning circuitry. For example, groupings and/or other classifications of the one or more input variable datasets and output variable dataset may be used to identify potential root causes of a fault within the industrial automation system 10. The predictions may be provided to downstream applications, including the local control system 42, the device control system 48, or the industrial automation application 56 which may perform actions based upon the predictions.

Causal inference is a process for determining the effect of a particular phenomenon within a larger system. In some cases, causal inference may be conducted in a study of a system when a measurement of a first variable is suspected to affect the measurement of a second variable. To evaluate whether the measurement of the first variable does affect the measurement of the second variable, causal inference may be conducted via the scientific method. That is, a null hypothesis is formulated and then subsequently tested via various statistical methods (e.g., frequentist statistical inference, Bayesian inference, etc.). Some efforts related to causal inference are utilized in an attempt to replicate experimental conditions.

It should be appreciated that the described embodiment of the local control system 42 is merely intended to be illustrative and not limiting. The local control system 42 may include one or more components of the device control system 48. In some cases, the device control system 48 may be one component of the local control system 42. That is, the device control system 48 may be part of a collection of modules.

As generally discussed above, the device control system 48 may interface with devices that may monitor and control various types of industrial automation equipment 50. Additionally or alternatively, the device control system 48 may monitor and gather datasets that relate to input variables for a particular device within the industrial automation system 10, and then identify and prioritize the storage of particular input variables determined to be correlated to an occurrence of a fault. To facilitate the identification of the particular input variables, present embodiments relate to various systems and methods for receiving datasets associated with devices in the industrial automation system 10 and identifying correlations and/or causal relationship between the received datasets and the occurrences of faults of the particular devices.

FIG. 4 illustrates an embodiment of a flow chart of a process 100 for generating a model for identifying potential causes to a detected fault and facilitating a root cause analysis to determine a cause of a particular fault experienced by a device within an industrial automation system 10. Although the following description of the process 100 will be described as being performed by the device control system 48, it should be noted that any suitable processor-based device (e.g., the edge computing device 58, the local control system 42, etc.) may be specially programmed to perform any of the processes described herein. Moreover, although the following description of the process 100 is described as including certain steps performed in a particular order, it should be understood that the steps of the process 100 may be performed in any suitable order, that certain steps may be omitted, that certain steps may be added, and/or that certain steps may be performed simultaneously.

At block 102, the device control system 48 may receive an installed base evaluation (IBE) associated with one or more industrial automation devices 20 located within an industrial automation system 10. That is, the device control system 48 may receive information detailing interconnectivity between the various industrial automation devices 20, location-based information relating to spacing and/or distribution of the industrial automation devices 20 within the industrial automation system 10, and the like. In some embodiments, the IBE may provide a graphical layout or visualization of the industrial automation system 10 to the display 86 of the device control system 48 so that an operator or user may view a layout of the multiple industrial automation devices 20 and their relationship with the various machines and industrial automation equipment 50 in the industrial automation system 10. The IBE data may be stored as a file or other computer-readable medium and may be generated based on a network query to identify the industrial automation devices 20, a user-generated list of the industrial automation devices 20, and the like.

At block 104, the device control system 48 may receive a first input variable dataset associated with a first industrial automation device 20 over a period of time. That is, the device control system 48 may receive multiple input variable signals from one or more sensors 16 that correspond with various operational parameters (e.g., temperature, flow rate, electrical power, etc.) during operation of the first industrial automation device 20. In some embodiments, the operational parameters may be associated with the first industrial automation devices 20 that operate as a portion of an operation associated with industrial automation equipment 50. The device control system 48 may receive and store the first input variable dataset in the memory 76 and/or storage 78 of the device control system 48.

At block 106, the device control system 48 may receive a second input variable dataset associated with a second industrial automation device 20 over the period of time. That is, the device control system 48 may receive multiple input variable signals from one or more sensors 16 that correspond with various operational parameters (e.g., temperature, flow rate, electrical power, etc.) during operation of the second industrial automation device 20. In certain embodiments, the second input variable dataset may correspond to the same period of time as the first input variable dataset. In some embodiments, the operational parameters may be associated with the second industrial automation devices 20 that operates as an additional portion of an operation associated with industrial automation equipment 50. The device control system 48 may receive and store the second input variable dataset in the memory 76 and/or storage 78 of the device control system 48.

At block 108, the device control system 48 may receive fault data corresponding to one or more faults that occurred on the first industrial automation device 20 during the period of time. That is, the device control system 48 may receive multiple output variable signals from one or more sensors 16 that correspond with various operational outputs of the first industrial automation device 20. For example, when the first industrial automation device 20 experiences a fault, the device may operate less efficiently, stop operating, or change its operations. In some cases, when the first industrial automation device 20 experiences a fault, the device control system 48 may receive associated information relating to the fault. For example, the device control system 48 may receive a time that the fault occurred. In other embodiments, the device control system 48 may retrieve input variable data from the first industrial automation device, the second industrial automation device 20, or both, at the time corresponding to the time that the fault occurred.

At block 110, the device control system 48 may identify one or more correlations and/or causal relationships between one or more of the input variables retrieved by the device control system 48 and the one or more faults experienced by the first industrial automation device 20. For example, in certain embodiments, the device control system 48 may identify that an input variable corresponding to the rotational speed of a motor (e.g., first industrial automation device 20) has an identifiable correlation (e.g., directly correlated, linearly correlated) with an occurrence of a fault associated with the first industrial automation device 20. That is, the device control system 48 may determine that as the rotational speed of the motor increases beyond a threshold rotational speed, a fault is likely to occur. In other embodiments, the device control system 48 may determine that as the rotational speed of the motor decreases below a different threshold rotational speed, a fault is likely to occur. In some cases, the device control system 48 may determine that one or more input variables in combination correlate with a fault occurring with the first industrial automation device 20. For example, the device control system 48 may determine that there is a correlation between one or more input variables of the second industrial automation device 20 and the occurrence of the fault experienced by the first industrial automation device 20. In one illustrative embodiment, the device control system 48 may identify a non-linear increase in electrical power (e.g., current, voltage, wattage, etc.) provided to the second industrial automation device 20 at the time period as being associated with the fault of the first industrial automation device 20. In such a scenario, the device control system 48 may determine that the increase in electrical power may have caused the fault in the first industrial automation device 20.

At block 112, the device control system 48 may determine weights for each input variable received by the device control system 48 based on the previously identified correlations and/or causal relationships. For example, the device control system 48 may assign a weight to each input variable of the multiple input variables corresponding to the operation of the first industrial automation device 20. That is, the assigned weight may correspond to a numerical value assigned to an input variable that indicates a degree of correlation between data observed in a dataset of the input variable to a particular output condition (e.g., normal operation, fault, etc.). In some embodiments, the numerical value may be a number between 0 and 1, with a number closer to 0 indicating that the data in the particular dataset of the particular input variable is less likely to be closely linked to the particular output condition. Additionally or alternatively, a numerical value closer to 1 may indicate that the data in the particular dataset of the particular input variable is more likely to be closely linked to the particular output condition. In other embodiments, an otherwise appropriate numerical value scale is used to indicate a weight associated with the particular input variable.

In some cases, the device control system 48 may send a notification that indicates that a change in weight to a particular input variable dataset has been determined. For example, the device control system 48 may output the notification via the communication component 72 to the supervisory control system 40, the local control system 42, the edge computing device 58, or otherwise appropriate computing device. In some embodiments, the notification may alert the user to the adjustment in the storage configuration associated with the particular input variable dataset. In a non-limiting example, the user may receive a notification that the input variable dataset relating to the rotational speed of the motor received an increase in weight, and therefore may utilize more memory space based on accompanying increases in frequency and/or duration of the dataset being stored in the memory 76 of the device control system 48.

At block 114, the device control system 48 may identify a root cause for the fault based on the weighted input variables. For example, the device control system 48 may determine that an input variable with a larger assigned weight may have caused a particular fault experienced by the first industrial automation device 20. To continue with one of the examples above, the device control system 48 may determine that the rotational speed of the motor exceeding the threshold rotational speed was the root cause of the particular fault of the first industrial automation device 20. In certain embodiments, the weights determined in block 108 may be adjusted based on user input related to the determination of the root cause of the fault. For example, if the device control system 48 receives user input indicative of an additional input variable (e.g., temperature of a motor, speed of a conveyer, pressure for a hydraulic fluid line, power received by the second industrial automation device 20, etc.) that caused the fault, the device control system 48 may dynamically adjust the assigned weights to increase an associated weight for the additional input variable. In other embodiments, the device control system 48 may reduce the assigned weight associated with the rotational speed of the motor, and in some embodiments, the device control system 48 may not adjust the previously assigned weights associated with the input variables. In some embodiments, as additional input variables are collected over time, the weights may also be updated based on the associated correlations.

At block 116, the device control system 48 may identify one or more datasets and/or one or more industrial automation devices 20 related to the root cause, the IBE data, the correlations, the causal relationships, and/or the weights assigned to the various input variables. For example, the device control system 48 may identify that a dataset of the input variable associated with the rotational speed of the motor may be related to the root cause of the fault experienced by the first industrial automation device 20. As such, the dataset of the input variable associated with the rotational speed of the motor may have received a higher weight (e.g., a weight close to 1) in block 112 as compared to others when the device control system 48 determined weights for the various input variables. The IBE data may also be utilized by the device control system 48 to establish that a particular dataset may be related to the root cause. For example, the device control system 48 may identify that the identified root cause of the fault is associated with an industrial automation device located proximate to, within a threshold distance of, or electrically connected to the first industrial automation device 20 within the industrial automation system 10.

At block 118, the device control system 48 may generate a model for the one or more related datasets and/or the one or more related industrial automation devices 20 in the industrial automation system 10. In an embodiment, the model may be generated based on the correlations, the determined weights, and the identified root cause as discussed previously in blocks 110-114. As such, the model may represent one or more causal relationships between the one or more related datasets and the occurrence of a fault on the one or more related industrial automation devices 20. Indeed, in certain embodiments, the model may be generated by utilizing machine learning algorithms to identify correlations or relationships (e.g., causal relationships) between anomalous data within the one or more related datasets and a particular occurrence of a fault. In some embodiments, the model may be dynamically updated based on updated input variable datasets, new correlations identified between the updated input variable datasets and a fault occurrence, and/or determinations of root causes of a fault based on a previously un-weighted input variable. In certain embodiments, the device control system 48 may employ the model to identify a root cause of a fault in response to the first industrial automation device 20 experiencing a fault. That is, the device control system 48 may utilize the model to efficiently identify the root cause of a particular fault experienced with the first industrial automation device 20, based on the related historical data, identified correlations, weights, and root causes used to generate the model.

Additionally or alternatively, the device control system 48 may store the model in a memory 76 and/or storage 78 of the device control system 48. That is, the device control system 48 may retrieve the model when a fault occurs and employ the model so that the model may facilitate a determination of a root cause of the fault. Over time, the device control system 48 may generate and store different models for different faults that have been detected or experienced by the first industrial automation device 20. Additionally, the device control system 48 may generate and store different models for different faults that have been detected or experienced by the other various industrial automation devices, the industrial automation equipment, and the like. As such, the device control system 48 may retain a library of models for identifying root causes of various faults for various types of equipment.

At block 120, the device control system 48 may adjust data acquisition parameters for particular industrial automation devices 20 associated with the industrial automation equipment 50 based on the model. For example, if the generated model determines that the rotational speed of the motor has a larger weight value (above a threshold weight value) assigned to this particular input variable as compared to others, the device control system 48 may increase a sample rate or increase an amount of data to store that corresponds to this particular input variable data set. In this way, the device control system 48 may gather and store more data that is determined to be more closely correlated with faults of industrial automation equipment 50. Conversely, if the model determines that an additional input variable has a weight value that is below a threshold weight value or relative to other input variables, then the device control system 48 may adjust the data acquisition parameters to decrease a sample rate or decrease an amount of data to acquire or store corresponding to the additional input variable. By virtue of this adjustment, the device control system 48 may store relatively more data that is more relevant regarding the operation of the industrial automation equipment 50, improving the efficiency and capability of the device control system 48 and local control system 42 to quickly and accurately identify the root cause of a fault occurrence within the industrial automation system 10 by capturing datasets that may be more closely correlated to a respective fault.

FIG. 5 illustrates an embodiment of a flow chart of a process 150 for determining a location of an industrial automation device associated with one or more anomalies detected in one or more related datasets. Although the following description of the process 150 will be described as being performed by the device control system 48, it should be noted that any suitable processor-based device (e.g., the edge computing device 58, the local control system 42, etc.) may be specially programmed to perform any of the processes described herein. Moreover, although the following description of the process 150 is described as including certain steps performed in a particular order, it should be understood that the steps of the process 150 may be performed in any suitable order, that certain steps may be omitted, that certain steps may be added, and/or that certain steps may be performed simultaneously.

In block 152, the device control system 48 may receive multiple input variables datasets associated with multiple industrial automation devices (e.g., a first industrial automation device 20, a second industrial automation device 20, etc.) in a facility over a period of time. That is, the device control system 48 may receive multiple input variable signals from one or more sensors 16 that correspond with various operational parameters (e.g., temperature, flow rate, electrical power, etc.) during operation of the industrial automation devices 20. In some embodiments, the operational parameters may be associated with the various industrial automation devices 20 that operate as a portion of an operation associated with industrial automation equipment 50 in an industrial automation system 10. The device control system 48 may receive and store the multiple input variable signals in the memory 76 and/or the storage 78 of the device control system 48.

In block 154, the device control system 48 may map the received input variable datasets into an analytics layer. For example, the analytics layer may include or make up a portion of the installed base evaluation (IBE) of the facility. In a non-limiting embodiment, the analytics layer may utilize the information from the IBE relating to how the operations of a particular industrial automation device 20 are affected by the operations of other industrial automation devices 20 operating proximate to the particular industrial automation device 20. For example, the analytics layer may provide information relating to how an atypical surge in power experienced by one or more industrial automation devices 20 at one location within the industrial automation system 10 may be related to a fault experienced by an additional industrial automation device 20 in proximity to the other devices that experienced the surge. While mapping the input variable datasets within the analytics layer, the device control system 48 may receive information relating to a location for the industrial automation devices 20 within the facility.

In block 156, the device control system 48 may determine a baseline operation of the multiple industrial automation devices based on the input variable datasets mapped into the analytics layer. That is, the device control system 48 may analyze the operations of the multiple industrial automation devices 20, the industrial automation equipment 50, and additional machinery over a period of time to determine the baseline operation. In some cases, the baseline operation may relate to a “normal” operation, corresponding to a scenario where most or all of the industrial automation devices 20 and/or the industrial automation equipment 50 are operating normally (e.g., operations without a fault, average production capacity, etc.). This determined baseline operation may be based on average operating conditions of the industrial automation system 10, user-defined characteristics that relate to a typical operation period for the industrial automation system 10, or a combination of multiple characteristics. In some cases, the baseline operation may be defined by an upper threshold and a lower threshold that indicate bounds of the baseline operation.

In block 158, the device control system 48 may receive updated input variable datasets for the multiple industrial automation devices (e.g., the first industrial automation device 20, the second industrial automation device 20, etc.) over an additional period of time. In a similar fashion to block 152, the device control system 48 may receive multiple input variable signals from one or more sensors 16 that correspond with various operational parameters (e.g., temperature, flow rate, electrical power, etc.) during operation of the industrial automation devices 20. After receiving the updated input variable datasets, the device control system 48 may integrate the updated input variable datasets into the analytics layer. In other embodiments, the device control system 48 may segregate the updated input variable datasets from the original input variable datasets used to build and map the analytics layer and baseline.

In block 160, the device control system 48 may compare the updated input variable datasets to the baseline operation. For example, in block 156, the device control system 48 may have determined that the baseline rotational speed of the motor may be 500 rpms. In certain embodiments, while comparing the updated input variable dataset corresponding to the rotational speed of the motor, the device control system 48 may determine that the rotational speed of the motor is below, substantially similar, or greater than the baseline value for the rotational speed of the motor. In block 162, the device control system 48 may detect one or more anomalies in the updated input variable datasets as compared to the baseline operation. In some cases, an anomaly may be defined as a value greater than an upper threshold (e.g., 5% above, 10% above, 20% above, 25% above, 50% above, 75% above, 100% above, etc.) of the baseline value. Additionally or alternatively, an anomaly may also correspond to a value less than a lower threshold (e.g., 5% below, 10% below, 20% below, 25% below, 50% below, 75% below, 100% below, etc.) of the baseline value. In certain embodiments, the device control system 48 may determine that a particular input variable dataset as compared to the baseline operation value is greater than the baseline operation value, but not exceeding the upper threshold as to qualify as an anomaly.

In block 164, after an anomaly has been detected, the device control system 48 may retrieve a model for related datasets and/or industrial automation devices for the facility. The device control system 48 may retrieve the model when an anomaly is detected and employ the model so that the model may facilitate a determination of a root cause of the anomaly. That is, the device control system 48 may store a model associated with a particular type of anomaly in the memory 76 and/or storage 78 of the device control system 48 and may store an additional model associated with an additional type of anomaly in the memory 76 and/or storage 78 of the device control system 48. Additionally or alternatively, the device control system 48 may store a model that generally relates to the operations of a particular industrial automation device 20 within the industrial automation system 10. In this case, in response to the particular industrial automation device 20 experiencing a particular anomaly, the device control system 48 may retrieve the model that is associated with the experienced anomaly and/or associated with the particular industrial automation device 20.

In block 166, the device control system 48 may identify one or more datasets or industrial automation devices 20 related to the one or more anomalies based on the model. For example, if a first industrial automation device 20 (e.g., a motor) experienced an anomalous condition of an elevated rotational speed as compared to the baseline operation of the motor, the device control system 48 may determine that a dataset corresponding to a power received by a second industrial automation device located proximate to the first industrial automation device in a time period preceding the anomaly may have contributed to the anomaly. In some embodiments, the model may identify multiple datasets that taken separately may not have caused an anomaly, but taken together combined to create the anomaly.

In block 168, the device control system 48 may adjust data acquisition parameters for the identified one or more related datasets and/or related industrial automation devices. For example, if the model determines that the rotational speed of the motor was above or below the baseline operation (above an upper threshold, below a lower threshold), the device control system 48 may increase a sample rate or increase an amount of data to store that corresponds to this particular input variable data set. In this way, the device control system 48 may gather and store more data that is determined to be more closely correlated with anomalies of the industrial automation devices 20. Conversely, if the model determines that an additional input variable was substantially similar (within the lower and upper threshold values) to the baseline operation value during a time preceding the experienced anomaly, then the device control system 48 may adjust the data acquisition parameters to decrease a sample rate or decrease an amount of data to store corresponding to the additional input variable. By virtue of this adjustment, the device control system 48 may store relatively more data that is more relevant regarding the operation of the industrial automation devices 20, improving the efficiency and capability of the device control system 48 and local control system 42 to quickly and accurately identify the root cause of an anomaly occurrence within the industrial automation system 10 by capturing datasets that may be more closely correlated to a respective fault.

In block 170, the device control system 48 may receive additional updated datasets associated with the one or more related datasets and/or the one or more related industrial automation devices, based on the adjusted data acquisition parameters implemented in block 168. For example, as compared to the input variable datasets received in block 152 or in block 158, the additional updated datasets may include more data (e.g., data more frequently sampled, data gathered over a longer duration, etc.) associated with the one or more related datasets and/or the one or more related industrial automation devices. At the same time, the additional updated datasets may include less data (e.g., data less frequently sampled, data gathered over a shorter duration, etc.) associated with the one or more datasets and/or the one or more industrial automation devices 20 that were not identified as related to the one or more anomalies based on the model.

In block 172, the device control system 48 may analyze intensity data of the updated datasets. For example, the device control system 48 may determine that one or more of the related datasets may show operation parameter values that exceed or are less than the baseline operation for the respective operation parameter values. Further, the device control system 48 may identify one or more of the industrial automation devices 20 that include output variables that fall outside the upper or lower thresholds of the baseline operation for these respective industrial automation devices 20. In certain embodiments, the intensity data may illustrate a relative amount that a particular dataset and/or industrial automation device 20 has exceeded an upper threshold of the baseline operation. In these cases, the device control system 48 may determine that a particular subset of the related datasets or a subset of the related industrial automation devices 20 may have a more intense (e.g., over 25% of the baseline operation value, over 50% of the baseline operation value, over 100% of the baseline operation value) anomalous operation as compared to the remaining datasets in the related datasets.

In block 174, the device control system 48 may cross-reference the intensity data with a respective location of the one or more industrial automation devices 20. For example, the device control system 48 may identify the related industrial automation devices 20 that experienced a greater intensity of the anomalous operation were located within a similar location within the facility. In some embodiments, the device control system 48 may utilize the location data included as a portion of the IBE data while cross-referencing the intensity data from the related datasets and the related industrial automation devices 20. At block 176, the device control system 48 may determine a location of an industrial automation device 20 associated with the one or more anomalies. For example, the device control system 48 may determine that one or more related industrial automation devices 20 located within a particular location within the facility experienced intense anomalous operations during a time period prior to the industrial automation equipment 50 experiencing a fault, or experiencing an anomalous operation. In this way, the device control system 48 may isolate a location within the facility as a likely location for the origination of the root cause, the anomalous operations, or both.

In block 178, the device control system 48 may send a command to one or more of the industrial automation devices 20 at the determined location. In some embodiments, the command may alter the operations of the one or more industrial automation devices 20. In other embodiments, the command may cause the one or more industrial automation devices 20 at the determined location to stop operations. By virtue of this, the device control system 48 may more efficiently analyze more relevant data relating to the occurrence of an anomaly and/or fault within the industrial automation system 10, identify a location within the facility that may have contributed to or been the root cause of the anomaly and/or fault, and output a command to correct the anomalous operation.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An industrial automation system comprising:
one or more industrial automation devices; and
a control system, wherein the control system comprises:
processing circuitry; and
a memory configured to store instructions that, when executed by the processing circuitry, cause the processing circuitry to:
receive a first input variable dataset associated with a first set of operations of a first industrial automation device over a period of time;
receive a second input variable dataset associated with a second set of operations of a second industrial automation device over the period of time;
receive fault data corresponding to one or more faults that occurred on the first industrial automation device;
identify at least one correlation between the first input variable dataset, the second input variable dataset, the fault data, or any combination thereof;
determine at least one weight for the first input variable dataset, the second input variable dataset, or both based on the at least one correlation;
identify a root cause for the one or more faults based on the at least one correlation, the at least one weight, or both;
identify one or more datasets and a subset of the one or more industrial automation devices related to the root cause; and
adjust at least one data acquisition parameter for at least one sensor configured to acquire the one or more datasets.

2. The industrial automation system of claim 1, wherein the instructions cause the processing circuitry to:
receive an installed base evaluation (IBE) data indicative of the one or more industrial automation devices; and
provide a visualization of a graphical layout of the one or more industrial automation devices within the industrial automation system to a display.

3. The industrial automation system of claim 1, wherein the at least one data acquisition parameter comprises a data acquisition frequency.

4. The industrial automation system of claim 1, wherein the control system comprises a human machine interface (HMI) configured to receive an input directly from an operator.

5. The industrial automation system of claim 1, wherein the instructions cause the processing circuitry to:
generate a model for the one or more datasets and the one or more industrial automation devices related to the root cause, wherein the model represents at least one causal relationship between the one or more datasets and the one or more faults.

6. The industrial automation system of claim 1, wherein the instructions cause the processing circuitry to:
receive one or more updated input variable datasets for the first industrial automation device, the second industrial automation device, or both, wherein the one or more updated input variable datasets are acquired based on the adjusted at least one data acquisition parameter;
receive an indication of an additional fault;
retrieve a model associated with the additional fault in response to receiving the indication; and
identify an additional root cause of the additional fault based on the model.

7. The industrial automation system of claim 1, wherein the instructions cause the processing circuitry to:
receive an input indicative of an additional input variable associated with the root cause;
update at least one weight for at least one input variable based on the input; and
update a model based on the at least one weight.

8. A method, comprising
receiving, via processing circuitry, a first input variable dataset associated with a first set of operations of a first industrial automation device over a period of time;
receiving, via the processing circuitry, a second input variable dataset associated with a second set of operations of a second industrial automation device over the period of time;
receiving, via the processing circuitry, fault data corresponding to one or more faults that occurred on the first industrial automation device;
identifying, via the processing circuitry, at least one correlation between the first input variable dataset, the second input variable dataset, the fault data, or any combination thereof;
determining, via the processing circuitry, at least one weight for the first input variable dataset, the second input variable dataset, or both based on the at least one correlation;
identifying, via the processing circuitry, a root cause for the one or more faults based on the at least one correlation, the at least one weight, or both;
identifying, via the processing circuitry, one or more datasets and a subset of the one or more industrial automation devices related to the root cause; and
adjusting, via the processing circuitry, at least one data acquisition parameter for at least one sensor configured to acquire the one or more datasets.

9. The method of claim 8, comprising:
receiving, via the processing circuitry, an installed base evaluation (IBE) data indicative of the one or more industrial automation devices; and
providing, via the processing circuitry, a visualization of a graphical layout of the one or more industrial automation devices to a display.

10. The method of claim 8, wherein the at least one data acquisition parameter comprises a data acquisition frequency.

11. The method of claim 8, wherein the processing circuitry communicatively couples to a human machine interface (HMI) configured to receive an input directly from an operator.

12. The method of claim 8, comprising:
generating, via the processing circuitry, a model for the one or more datasets and the one or more industrial automation devices, wherein the model represents at least one causal relationship between the one or more datasets and the one or more faults.

13. The method of claim 8, comprising:
receiving, via the processing circuitry, one or more updated input variable datasets for the first industrial automation device, the second industrial automation device, or both, wherein the one or more updated input variable datasets are acquired based on the adjusted at least one data acquisition parameter;
receiving, via the processing circuitry, an indication of an additional fault;
retrieving, via the processing circuitry, a model associated with the additional fault in response to receiving the indication; and
identifying, via the processing circuitry, an additional root cause of the additional fault based on the model.

14. The method of claim 8, comprising:
receiving, via the processing circuitry, an input indicative of an additional input variable associated with the root cause;
updating, via the processing circuitry, at least one weight for at least one input variable based on the input; and
updating, via the processing circuitry, a model based on the at least one weight.

15. A non-transitory computer-readable medium comprising computer-executable instructions that, when executed by at least one processor, cause the at least one processor to perform operations comprising:
receiving a first input variable dataset associated with a first set of operations of a first industrial automation device over a period of time;
receiving a second input variable dataset associated with a second set of operations of a second industrial automation device over the period of time;
receiving fault data corresponding to one or more faults that occurred on the first industrial automation device;
identifying at least one correlation between the first input variable dataset, the second input variable dataset, the fault data, or any combination thereof;
determining at least one weight for the first input variable dataset, the second input variable dataset, or both based on the at least one correlation;
identifying a root cause for the one or more faults based on the at least one correlation, the at least one weight, or both;
identifying one or more datasets and a subset of the one or more industrial automation devices related to the root cause; and
adjusting at least one data acquisition parameter for at least one sensor configured to acquire the one or more datasets.

16. The non-transitory computer-readable medium of claim 15, wherein the computer-executable instructions cause the at least one processor to:
receive an installed base evaluation (IBE) data indicative of the one or more industrial automation devices; and
provide a visualization of a graphical layout of the one or more industrial automation devices to a display.

17. The non-transitory computer-readable medium of claim 15, wherein the at least one data acquisition parameter comprises a data acquisition frequency.

18. The non-transitory computer-readable medium of claim 15, wherein the computer-executable instructions cause the at least one processor to:
generate a model for the one or more datasets and the one or more industrial automation devices, wherein the model represents at least one causal relationship between the one or more datasets and the one or more faults.

19. The non-transitory computer-readable medium of claim 15, wherein the computer-executable instructions cause the at least one processor to:
receive one or more updated input variable datasets for the first industrial automation device, the second industrial automation device, or both, wherein the one or more updated input variable datasets are acquired based on the adjusted at least one data acquisition parameter;
receive an indication of an additional fault;
retrieve a model associated with the additional fault in response to receiving the indication; and
identify an additional root cause of the additional fault based on the model.

20. The non-transitory computer-readable medium of claim 15, wherein the computer-executable instructions cause the at least one processor to:
receive an input indicative of an additional input variable associated with the root cause;
update at least one weight for at least one input variable based on the input; and
update a model based on the at least one weight.
